(19) United States
(12) Patent Application Publication
(10) Pub. No.: US 2002/0152356 A1
(43) Pub. Date: Oct. 17, 2002

(54) Low-power cache memory and method of determining hit/miss thereof

(75) Inventors: Tae-Chan Kim, Suwon (KR); Soo-Won Kim, Seoul (KR)

Correspondence Address: Anthony P. Onello, Jr., MILLS & ONELLO LLP, Eleven Beacon Street, Suite 605, Boston, MA, 02108, US

(73) Assignee: Samsung Electronics Co., Ltd.

(21) Appl. No.: 10/073,481

(22) Filed: Feb. 11, 2002

(30) Foreign Application Priority Data
Feb. 13, 2001 (KR) 2001-08290

(51) Int. Cl. G06F 12/00

(52) U.S. Cl. 711/118; 713/320

(57) ABSTRACT

In a low-power cache memory and a method of determining a hit/miss thereof, a tag is divided into pre-select bits and post-select bits. In a first phase for comparison of the tag, the pre-select bits of the cache memory are compared with pre-select bits of the processor to generate a first hit/miss signal. In the first phase, when the first hit/miss signal is in a miss state, the cache memory discriminates a cache miss. On the other hand, when the first hit/miss signal is in a hit state in the first phase, in a second phase, the post-select bits of the cache memory are compared with tag bits from the processor corresponding to the pre-select bits to generate a second hit/miss signal. Similarly, in the second phase, when the second hit/miss signal is in a hit state, the cache memory discriminates a cache hit.

### RELATED APPLICATION

This application relies for priority upon Korean Patent Application No. 2001-08290, filed on Feb. 13, 2001, the contents of which are herein incorporated by reference in their entirety.

### FIELD OF THE INVENTION

The present invention relates to a cache memory, and more particularly to a low-power cache memory and a method of determining a hit/miss thereof.

### BACKGROUND OF THE INVENTION

In current electronic systems that are controlled by a Micro Controller Unit (MCU) or a Micro Processor Unit (MPU), the systems continually evolve as the operational rate and performance of the processors improve. The structure of a processor is designed to be suitable for 8 bits, 16 bits, 32 bits, 64 bits and more than 64 bits according to the width of data bus or the number of data bit lines. Also, the technology relating to the processor structure tracks the trend toward an increased number of data bits, which lends to an improvement in the performance of the electronic systems.

In addition, as the operating speed of the processor and the number of bits on the data bus are increased, the related amount of consumed electric power is also increased. Accordingly, consumption of electric power for a high-performance and high-speed processor and other devices must be considered. Designs utilizing low-power technology have therefore become popular.

In general, memories operate at a lower operating speed than processors. Data supplied memory external to the processor should be supplied according to the relatively fast operating speed of the processor. However, since access speed of the memory is relatively low, cache memory is typically employed to compensate for the relatively low operating speed of the external memory. The operating speed of cache memory tends to also increase with that of the processor. Thus, as the amount of a consumed electric power is increased, distribution of a consumption of electric power of the cache memory becomes an important factor.

FIG. 1 is a block diagram illustrating the construction of a cache memory for explaining a cache tag-comparing algorithm according to conventional approaches.

Referring to FIG. 1, there is shown an address 10 allocated to a cache memory from a processor, which is divided into three fields, i.e., a tag field 12, an index field 14 and an offset field 16. Typically, a cache memory 20 includes a tag cache 22 for storing tags, a data cache 24 for data (or commands) and a comparator 30 for comparing the tag 12 in the address 10 allocated to the cache memory 20 from the processor with the tags stored in the tag cache 22, respectively. In the conventional approach, during the tag comparing operation, the comparator 30 simultaneously compares all the bits of the tag 12 allocated to the cache memory 20 from the processor with all the bits of one of the tags stored in the tag cache 22. As a result, an amount of current is drawn corresponding to a value obtained by multiplying the number of bits in a tag address domain by an entry upon access of an SRAM, which contributes to an increase in the amount of a consumed electric power upon driving of the cache memory. FIGS. 2A and 2B show timing charts of the cache memory shown in FIG. 1.

### SUMMARY OF THE INVENTION

To overcome the limitations of the conventional approach described above, it is an object of the present invention to provide a cache memory having low-power characteristics.

Another object of the present invention is to provide a method of determining hit/miss of a cache memory in which the amount of a consumed electric power of the cache memory is reduced.

According to an aspect of the present invention, there is provided a cache memory, comprising: a tag cache adapted to store tags; a first comparator adapted to compare a first part of a tag provided thereto from a processor with a first part of a tag provided thereto from the tag cache and corresponding to the first part of the tag provided thereto from the processor so as to generate a first hit/miss signal. The cache memory discriminates a cache miss, when the first hit/miss signal is in a miss state.

Preferably, the cache memory may further include a second comparator adapted to compare the other, second, part of the tag provided thereto from the processor with the other, second, part of the tag provided thereto from the tag cache and corresponding to the second part provided thereto from the processor, when the first hit/miss signal is in a hit state, so as to generate a second hit/miss signal.

When the second hit/miss signal is in a hit state, the cache memory discriminates a cache hit.

Preferably, the cache memory may further include a transfer circuit adapted to selectively transfer the second part of the tag from the processor and the second part of the tag from the tag cache corresponding to the second part from the processor to the second comparator in response to the first hit/miss signal. The transfer circuit transfers the second part of the tag from the processor and the second part of the tag from the tag cache to the second comparator when the second hit/miss signal is in a hit state. The transfer circuit also interrupts the transfer of the second part of the tag from the processor and the second part of the tag from the tag cache to the second comparator when the second hit/miss signal is in a miss state. When the second hit/miss signal is in a miss state, the cache memory discriminates a cache miss.

According to another aspect of the present invention, there is also provided a method of determining a hit/miss of a cache memory, comprising the steps of: determining whether or not a first part of a tag from a processor is identical with a first part of a tag from the tag cache corresponding to the first part of the tag from the processor; and discriminating a cache miss when the first part of the tag from the processor is not identical with the corresponding first part of the tag from the tag cache.

Preferably, the method may further include the steps of: determining whether or not the other, second, part of the tag from a processor is identical with the other, second, part of the tag from the tag cache corresponding to the second part of the tag from the processor when the first part of the tag from the processor is identical with the corresponding first part of the tag from the tag cache; and discriminating a cache hit when the second part of the tag from the processor is identical with the corresponding second part of the tag from the tag cache.

Preferably, the method may further include the step of discriminating a cache miss when the second part of the tag from the processor is not identical with the corresponding second part of the tag from the tag cache.

According to the method of the present invention, an access activity in a cache memory is reduced, which makes it possible to implement a low-power cache memory.

### BRIEF DESCRIPTION OF THE DRAWINGS

The foregoing and other objects, features and advantages of the invention will be apparent from the more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram illustrating the construction of a cache memory according to the prior art;

FIGS. 2A and 2B are timing charts illustrating examples of different waveforms from the cache memory of FIG. 1;

FIG. 3 is a block diagram illustrating the construction of a cache memory according to the present invention;

FIG. 4 is a graph illustrating the relationship between a value of consumed electric power calculated using an expression and a value of consumed electric power measured through an experiment depending on the proposed/conventional ratio and the number of pre-select bits; and

FIGS. 5A and 5B are timing charts illustrating examples of different waveforms from the cache memory of FIG. 3.

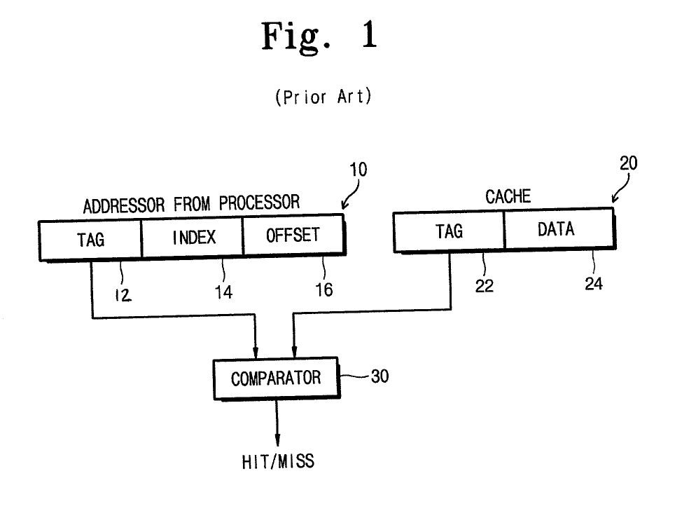

### DETAILED DESCRIPTION OF PREFERRED EMBODIMENTS

It should be understood that the description of the preferred embodiment is merely illustrative and that it should not be taken in a limiting sense. In the following detailed description, several specific details are set forth in order to provide a thorough understanding of the present invention. It will be obvious, however, to one skilled in the art that the present invention may be practiced without these specific details.

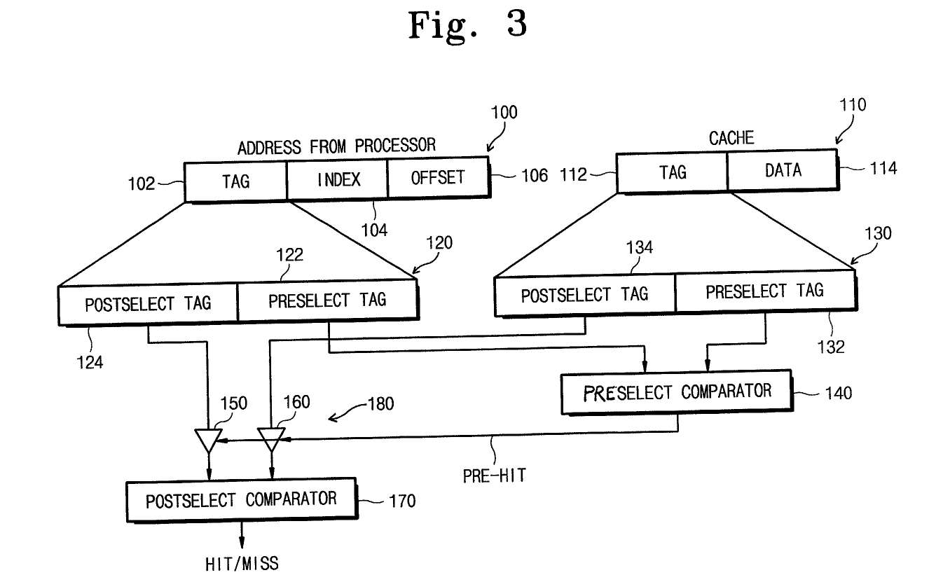

FIG. 3 is a block diagram illustrating the construction of a cache memory according to the present invention. Referring to FIG. 3, an address 100 of a cache memory 110 is divided into three fields, i.e., a tag field 102, an index field 104 and an offset field 106. The cache memory 110 includes a tag cache 112 for storing tags and a data cache 114 for storing data (or commands). The tag 102 or the tag cache 112 is preferably divided into two fields. In particular, the tag 102 or the tag cache 112 is further divided into at least two fields, i.e., a pre-select tag field 122 and a post-select tag field 124 or a pre-select tag field 132 and a post-select tag field 134 respectively. The cache memory 110 further includes two comparators, i.e., a pre-select comparator 140 and a post-select comparator 170, and a transfer circuit 180 consisting of transfer gates 150 and 160.

The present invention has characteristics of minimizing consumption of electric power that occurs upon access of a cache memory through a sequential comparison process using two phases.

In FIG. 3, in a first phase, the pre-select comparator 140 compares pre-select address bits stored in the pre-select tag field 132 with address bits corresponding to the pre-select tag field 122 within a processor so as to generate a first hit/miss signal (Pre-hit) for an entry that has been hit.

In a second phase, the post-select comparator 170 compares post-select address bits stored in the post-select tag field 134 with address bits corresponding to the post-select tag field 124 within the processor in an entry selected by the first hit/miss signal. The transfer circuit 180 may optionally selectively limit the transfer of the post-select tags 124, 134, based on the result of the first phase. Namely, if the pre-select comparator 140 determines that a miss has occurred, there is no need to perform the post-select comparison at comparator 170, thereby limiting the amount of current drawn for the comparison. Through the mechanism of the present invention, access activity is reduced upon access of a cache memory (or SRAM), so that a total consumption of electric power of the cache is minimized.

In the meantime, a directory SRAM (not shown) requires separation of pre-select bits and post-select bits such that the pre-select bits can be independent enough to selectively discriminate respective entries. At this point, it is important that minimal consumption of electric power be maintained when the access of a cache memory is not in progress, i.e., the cache memory is not selected.

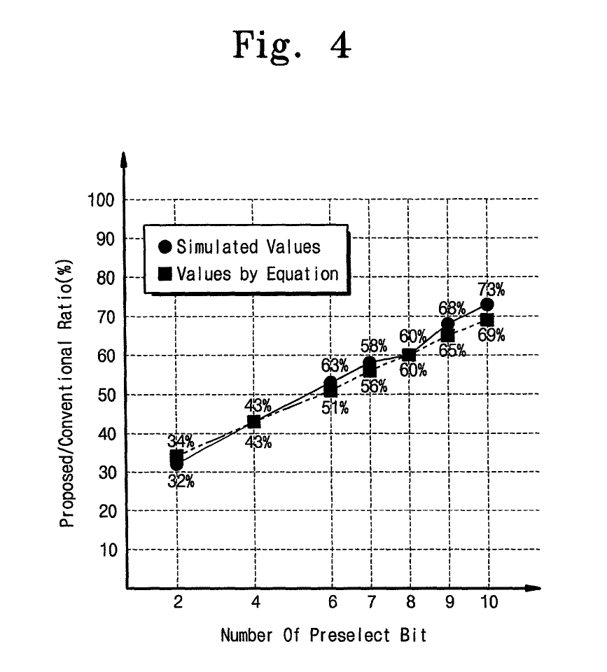

FIG. 4 is a graph illustrating a result of an experiment for reflecting the contents of a cache memory structure proposed in the present invention with an actual design of the cache memory, which exhibits a result from an experiment on an effect of a decrease in a consumption of electric power of a directory SRAM depending on the number of bits in a pre-select tag address field 60 when assuming that the proportion of selection of an entry by the pre-select bits is 100%.

Referring to FIG. 4, it has been shown that if a total of 17 bits are in a tag address field 102, 112 and 7 bits are in a pre-select tag address field 122, 132, the total consumption ratio of electric power of a tag cache is 58%. Also, it can be understood from FIG. 4 that the number of bits in the pre-select tag address affects the amount of decrease in consumption of electric power in the cache memory. Particularly, if an application program portion of a processor selectively discriminates respective entries with a small number of pre-select bits, an allocation of a small number of pre-select bits can reduce a large amount of consumed power. On assuming that an entry has been selected perfectly by the pre-select bits, the ratio of a decrease in a consumption of electric power can be expressed in the following equation:

((NPSB*NW+(NTADDB−NPSB))/NTADDB*NW

NPSB: the number of pre-select bits

NW: the number of ways

NTADDB: the number of tag address bits

Here, the tag address bit number (NTADDB) refers to the number of bits in a tag address field stored in a directory SRAM.

With reference to the above expression, it can be seen that the number of entries, the number of pre-select bits and the number of tag address bits affect a decrease in a consumption of electric power. That is, as the number of entries is increased and as the number of pre-select bits becomes smaller than the number of bits in the tag address field, the consumption of electric power can be greatly improved according to the present invention.

TABLE 1

| | |
|---|---|
| Gate number of typical structure (except | 1909 |
| SRAM) | |
| Gate number of proposed structure | 2058 |
| (except SRAM) | |
| SRAM gate number of typical structure | 140051 |
| SRAM gate number of proposed structure | 146686 |

In Table 1, the number of gates in a typical structure is compared with the number of gates in the proposed structure.

Referring to Table 1, a design based on the proposed structure requires an extra 150 gates. Accordingly, only when the amount of increase in consumed power of the added circuitry is smaller than that of the resulting decrease in consumed power, is the proposed method of the present invention effective. It has been seen from an experiment that when a total of 17 bits are in the tag address field, 7 bits are in the index address field and 4 bits are in the offset address field, if 7 bits are in the pre-select tag address field 122, 132, the ratio of the resulting decrease in consumed power by an access activity of SRAM is 17% and the ratio of the increase in consumed power resulting form the added controller circuitry is 3%. Accordingly, a net gain of 14% in terms of a consumption of electric power is accomplished in this example.

In addition, the present invention is applicable to examination of the content of 4-way set associative cache using a combination cache. However, a Virtual Indexed Physical Tagged Cache connected to a process for improving the hit ratio of a cache employs a cache including a great number of entries in view of an allocation of addresses.

Accordingly, in the case the present invention utilizing the foregoing sequential tag-comparing algorithm, it can be expected that a set combination cache including many entries such as a 64 way set associative cache will be larger than a 4 way set associative cache in the degree of decrease in consumption of electric power.

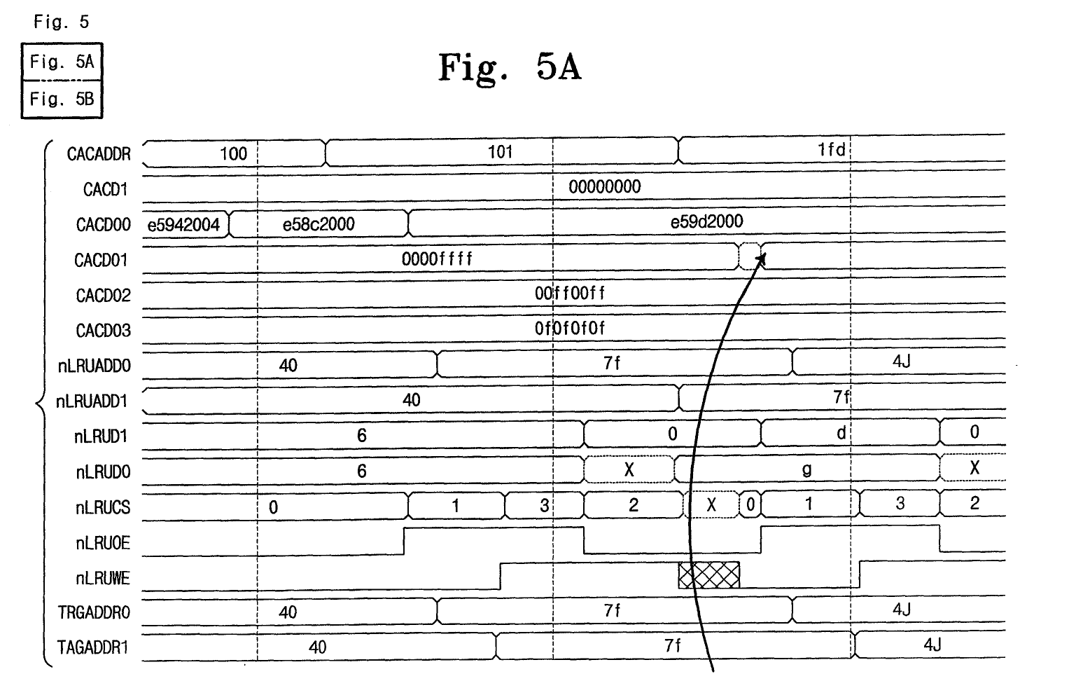

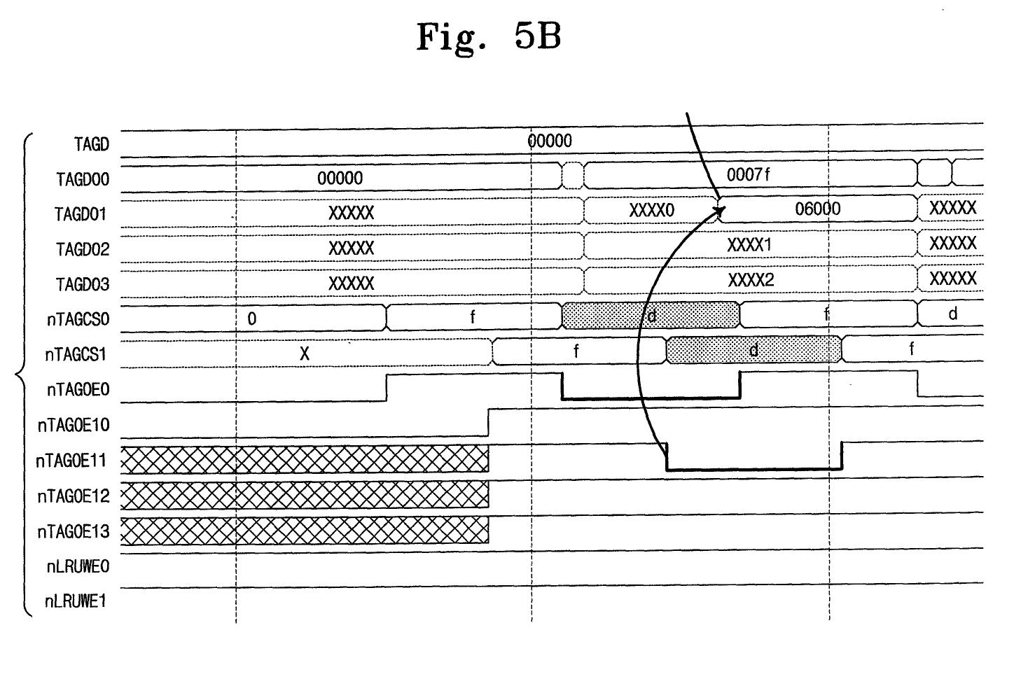

FIGS. 5A to 5B are timing charts illustrating examples of different waveforms in a cache memory embodying the sequential tag-comparing approach of the present invention and the structure of a general cache memory.

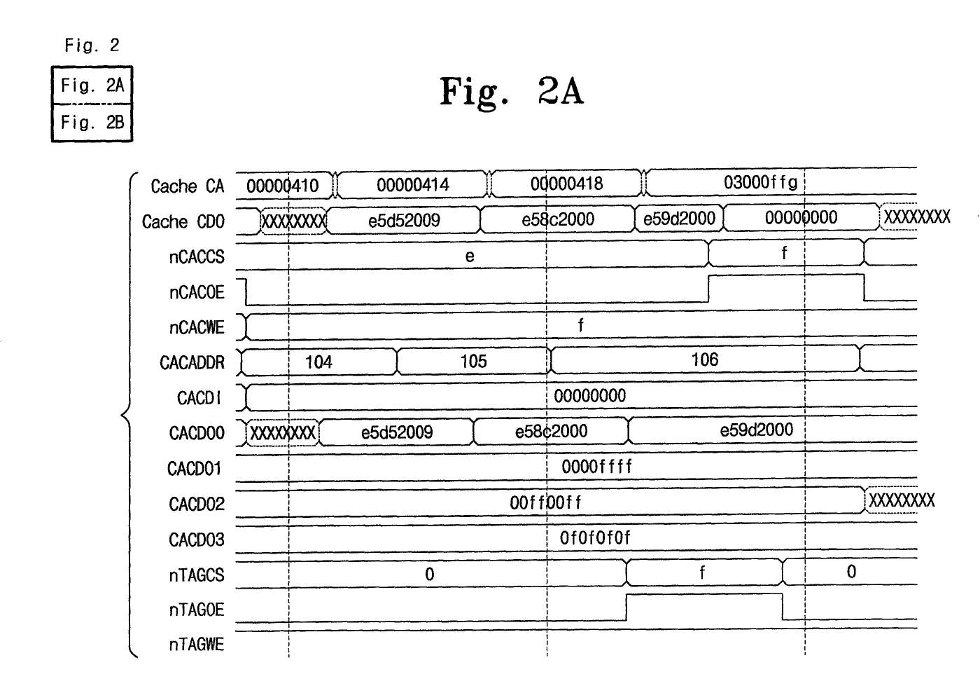

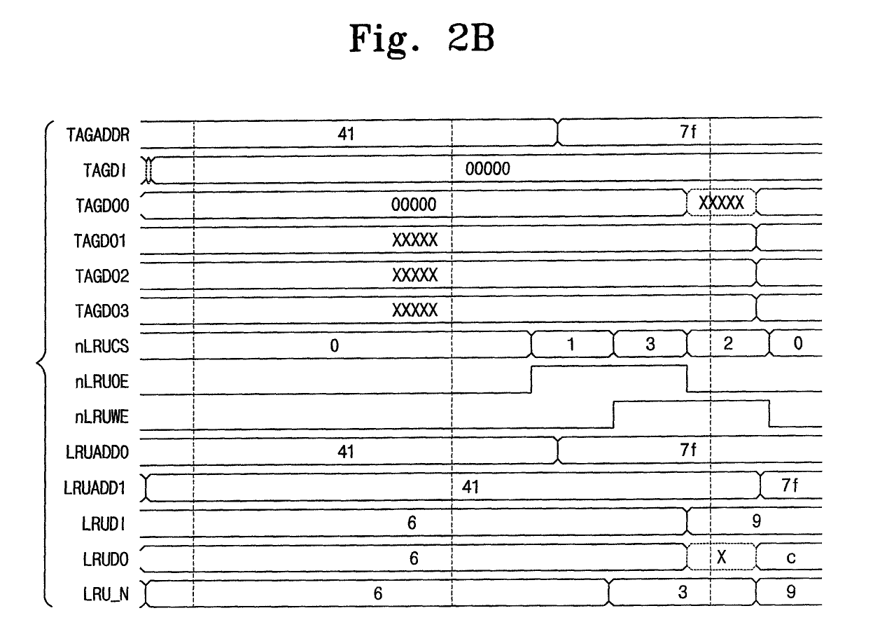

Referring to FIGS. 2A to 2B and 5A to 5B, TAGADDR is divided into TAGADDR0 and TAGADDR1, nTAGCS is divided into nTAGCS0 and nTAGCS1, and nTAGOE is divided into nTAGOE0 and nTAGOE10, nTAGOE11, nTAGOE12 and nTAGOE13 to generate a signal. A value of 0 is output from nTAGCS0 to select all the entries, and a value of d is output from nTAGCS1 to select a second entry. Accordingly, nTAGOE11 is selected to output a data value of the cache.

As can be seen from the foregoing, according to the present invention, the dual-phase tag comparison process allows for implementation of a low-power cache memory, thereby decreasing overall power consumption in the resulting product.

While this invention has been particularly shown and described with references to preferred embodiments thereof, it will be understood by those skilled in the art that various changes in form and details may be made herein without departing from the spirit and scope of the invention as defined by the appended claims.

What is claimed is:

1. A cache memory, comprising:
a tag cache adapted to store tags; and
a first comparator adapted to compare a first part of a processor tag provided thereto from a processor with a first part of a cache tag provided thereto from the tag cache and corresponding to the first part of the processor tag so as to generate a first hit/miss signal,
whereby the cache memory discriminates a cache miss when the first hit/miss signal is in a miss state.

2. The cache memory according to claim 1, further comprising a second comparator adapted to compare a second part of the processor tag provided thereto from the processor with a second part of the cache tag provided thereto from the tag cache and corresponding to the second part of the processor tag, when the first hit/miss signal is in a hit state, so as to generate a second hit/miss signal, whereby when the second hit/miss signal is in a hit state, the cache memory discriminates a cache hit.

3. The cache memory according to claim 2, further comprising a transfer circuit adapted to selectively transfer the second part of the processor tag and the second part of the cache tag corresponding to the second part of the processor tag to the second comparator in response to the first hit/miss signal,
whereby the transfer circuit transfers the second part of the processor tag and the second part of the cache tag to the second comparator when the first hit/miss signal is in a hit state, and interrupts the transfer of the second part of the processor and the second part of the cache tag to the second comparator when the first hit/miss signal is in a miss state.

4. The cache memory according to claim 2, wherein when the second hit/miss signal is in a miss state, the cache memory discriminates a cache miss.

5. A method of determining a hit/miss of a cache memory, comprising the steps of:
determining whether a first part of a processor tag from a processor is identical with a first part of a cache tag from the cache corresponding to the first part of the processor tag; and
discriminating a cache miss when the first part of the processor tag is not identical with the corresponding first part of the cache tag.

6. The method according to claim 5, further comprising the steps of:
determining whether a second part of the processor tag from the processor is identical with a second part of the cache tag from the cache corresponding to the processor tag when the first part of the processor tag is identical with the corresponding first part of the cache tag; and
discriminating a cache hit when the second part of the processor tag is identical with the corresponding second part of the cache tag.

7. The method according to claim 6, further comprising the step of discriminating a cache miss when the second part of the processor tag is not identical with the second part of the cache tag.
